(19) United States
(12) Patent Application Publication
(10) Pub. No.: US 2014/0334509 A1
(43) Pub. Date: Nov. 13, 2014

(54) METHOD AND DEVICE FOR PROCESSING MATERIALS USING A PULSED LASER BEAM GENERATED BY A FIBER LASER

(71) Applicant: ROFIN-BAASEL LASERTECH GMBH & CO. KG, STARNBERG (DE)

(72) Inventors: MARKUS ROEHNER, STARNBERG (DE); ERICH BOECK, STARNBERG (DE); BENJAMIN ERBEN, GROEBENZELL (DE); ERICH SCHMUCKER, FELDAFING (DE); JUERGEN STAEBLEIN, TUTZING (DE)

(21) Appl. No.: 14/336,025

(22) Filed: Jul. 21, 2014

Related U.S. Application Data
(63) Continuation of application No. PCT/EP2013/050905, filed on Jan. 18, 2013.

(30) Foreign Application Priority Data
Jan. 20, 2012 (DE) 102012200849.7
May 18, 2012 (DE) 102012208330.8

(51) Int. Cl. H01S 3/10

(52) U.S. Cl. CPC H01S 3/10
USPC 372/38.03

(57) ABSTRACT

A method and a device include a fiber laser generating a laser pulse for processing materials. An optical switching element disposed in a beam path of a laser beam is closed at the earliest when an output power of the laser beam falls below a specified value.

### CROSS-REFERENCE TO RELATED APPLICATION

This is a continuation, under 35 U.S.C. §120, of copending International Application No. PCT/EP2013/050905, filed Jan. 18, 2013, which designated the United States; this application also claims the priority, under 35 U.S.C. §119, of German Patent Application DE 10 2012 200 849.7, filed Jan. 20, 2012 and German Patent Application DE 10 2012 208 330.8, filed May 18, 2012; the prior applications are herewith incorporated by reference in their entirety.

### BACKGROUND OF THE INVENTION

### Field of the Invention

The invention relates to a method for material processing using a pulsed laser beam generated by a fiber laser. The invention also relates to a device suitable for carrying out the method.

In the processing of materials using a laser beam, fiber lasers are being used ever more often due to their compact structure, their high efficiency and the high beam quality of the laser beam generated thereby. Particularly in applications in which the material is melted by a pulsed laser beam, however, a range of manufacturing technology problems have arisen. For instance, when melting and partially melting inorganic, for example metallic or ceramic powders, or organic powders, deficiencies in the form of the formation of cavities or positions of lower thickness have been found to an increased extent. In welding applications as well, non-uniform weld beads or, in spot welding, reduced-quality welds, have been observed.

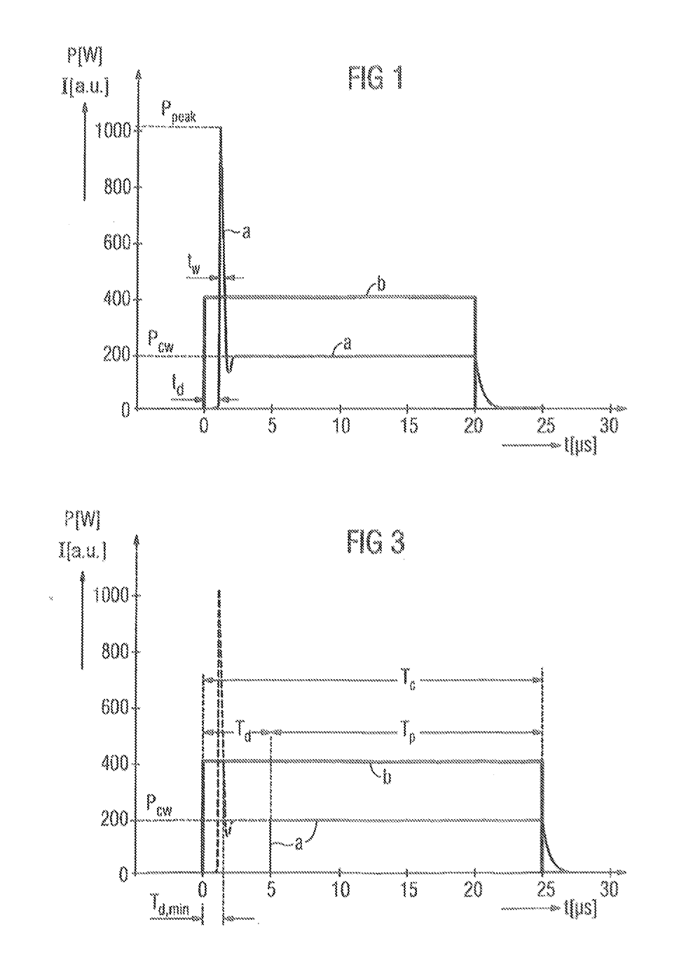

The observed negative effects are substantially caused by a pronounced primary relaxation pulse, or peak, occurring to a pronounced extent at the start of the laser emission, particularly in the case of cw fiber lasers or rapidly modulated gain-switch fiber lasers, in which the power of the pulse or peak may be several times the nominal cw power. In the diagram of FIG. 1, curve a shows the typical time profile of the output power P of the laser beam generated by a fiber laser when its diode laser, used as a pump light source, is driven with a current pulse J represented in a curve b. In this diagram, it can be seen that the start of the laser emission is delayed by a time t_{d} relative to the start of the current pulse J. The output power P then increases rapidly to a maximum value Pₚₑₐₖ before settling after this brief rise at the cw power P_{cw}, which in the example is only 20% of the maximum power Pₚₑₐₖ in the relaxation pulse. The delay time t_{d}, maximum value Pₚₑₐₖ and width t_{w} of the relaxation pulse in this case depend, inter alia, on the pulse frequency, the pulse width and the desired cw power P_{cw}.

In European Patent Application EP 2 136 439 A2, corresponding to U.S. Pat. Nos. 7,953,126 and 8,149,885, it is therefore proposed to suppress the relaxation pulse by controlling the current pulse supplied to the diode laser used as a pump source, in which the current pulse Js set in a first time segment to a low initial value with which the laser output power at most reaches a value which is low enough to prevent the occurrence of a relaxation pulse. In a second time segment, the current pulse Js then set to a final value. Depending on the desired final value of the laser output power, the occurrence of a relaxation pulse can be avoided by suitable selection of the laser output power in the first time segment and the duration of the latter.

### SUMMARY OF THE INVENTION

It is accordingly an object of the invention to provide a method and a device for processing materials using a pulsed laser beam generated by a fiber laser, which overcome the hereinafore-mentioned disadvantages and substantially avoid the aforementioned undesired effects of the heretofore-known methods and devices of this general type.

With the foregoing and other objects in view there is provided, in accordance with the invention, a method for material processing using a pulsed laser beam generated by a fiber laser, which comprises closing an optical switching element disposed in a beam path of the laser beam at the earliest when an output power of the laser beam falls below a predetermined value.

By virtue of a suitable selection of the predetermined value, the material processing begins at the earliest when, in the event of the occurrence of a relaxation peak, the power of the latter has fallen to a value at which the aforementioned disadvantages no longer occur. Accordingly, the processing results in the material processing, in which melting or partial melting of the material is an important part of the processing operation, are significantly improved.

In the following, the closure of an optical switching element is intended to mean a process in which the switching element is put into a state in which the laser beam is transmitted.

In accordance with another mode of the invention, if the predetermined value is two times the cw output power occurring within the pulse duration when cw operation is reached, the aforementioned disadvantages can be avoided reliably.

In accordance with a further mode of the invention, since the processing results achieved are commensurately better when the difference between the maximum power occurring at the start of the pulse and the cw power subsequently established is less, according to a preferred configuration of the invention, the output power of the laser beam when the optical switching element is closed exceeds the cw output power by at most 50%, preferably at most 10%.

In accordance with an added mode of the invention, if a measurement quantity correlated with the output power of the laser beam is recorded and used in order to control the switching element, elaborate calibration measurements characterizing the switch-on behavior of the fiber laser and the switching behavior of the optical switching element, and control measurements possibly to be carried out at regular time intervals in order to establish the switching time, can be obviated.

With the objects of the invention in view, there is concomitantly provided a device for material processing using a pulsed laser beam generated by a fiber laser, the device comprising a diode laser for pumping a laser fiber of the fiber laser, a controllable current source for supplying the diode laser with a current pulse, an optical switching element disposed in the beam path of the laser beam, and a control unit for carrying out the method according to the invention.

Other features which are considered as characteristic for the invention are set forth in the appended claims.

Although the invention is illustrated and described herein as embodied in a method and a device for processing materials using a pulsed laser beam generated by a fiber laser, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

FIG. 1 is a diagram in which a current pulse J in arbitrary units (a.u.) for driving a diode laser used for optical pumping, and an output power P of a fiber laser optically pumped in that way according to the prior art, are plotted against time t;

FIG. 2 is a schematic and block diagram of a laser system suitable for carrying out the method according to the invention;

FIG. 3 is a diagram in which the output power P of the fiber laser and the current pulse J are likewise plotted against time t, and in which a primary relaxation peak is blocked with the aid of an optical switching element; and

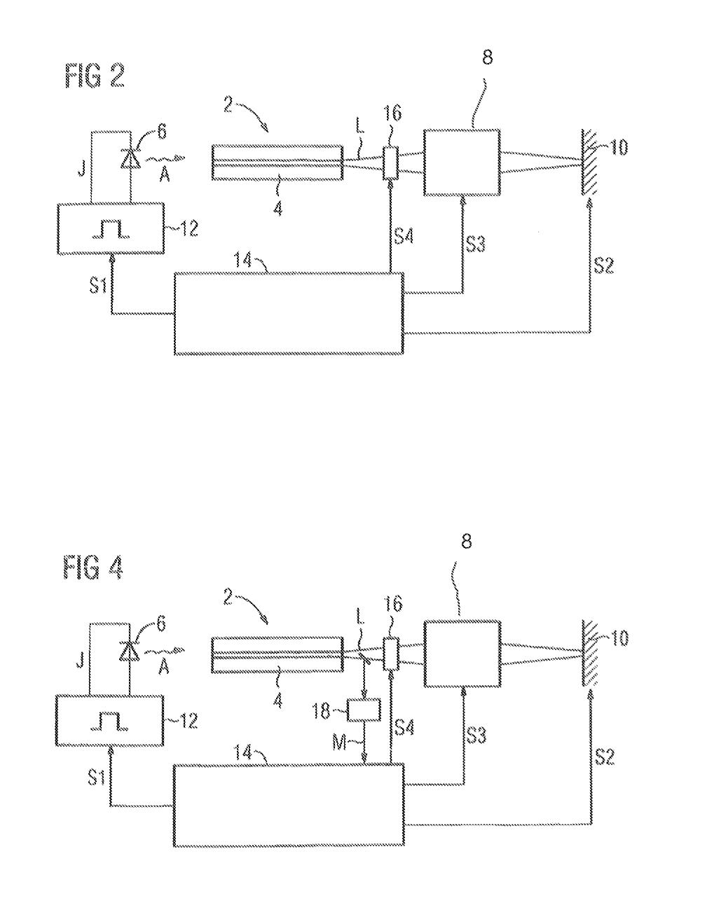

FIG. 4 is a schematic and block diagram of an advantageous configuration of a laser system suitable for carrying out the method according to the invention, having a radiation detector disposed in a beam path of a laser beam in order to record a measurement quantity correlated with an output power.

### DETAILED DESCRIPTION OF THE INVENTION

Referring now to the figures of the drawings in detail and first, particularly, to FIG. 2 thereof, there is seen a laser system containing a fiber laser 2 having a laser fiber 4 which is optically pumped by a diode laser 6. A pump light A (pump laser pulse) emitted by the diode laser 6, which is generally a configuration of a plurality of individual emitters, is coupled into a pump fiber disposed along the laser fiber 4, or into a lateral surface of the laser fiber 4, from where it enters a laser-active fiber core. A laser beam L generated by the laser fiber 4 is focused by a symbolically illustrated imaging and beam guiding instrument 8 onto a material 10 to be processed. The diode laser 6 is supplied with a current pulse J by a controllable current source 12. The current source 12 is controlled by control signals S1 from a central control unit 14, in which case, in addition to its amplitude and duration, the pulse shape of the current pulse J may also be controlled variably. Through the use of further control signals S2, S3, the control unit 14 controls the relative movement between the material 10 and the laser beam L, as well as other parameters for the processing operation.

The laser fiber 4 is followed externally by an optical switching element 16 controlled by the control unit, for example an optical switch, a switchable absorber or a switchable reflector, which is not closed until after a delay time T_{d} and transmits the laser beam L in the direction of the material 10 when the primary relaxation pulse has decayed and the output power of the laser beam has fallen below a predetermined value. This value depends on the nature of the material processing, the material and the power desired for the processing, and needs to be experimentally determined according to the application. The diode laser 6 can therefore be driven with a square-wave current pulse J for which the occurrence of a relaxation pulse is unavoidable, since the latter is at least partially optically blocked i.e. not delivered to the material.

This is represented in the diagram of FIG. 3, in which the delay time T_{d} is large enough that, when the optical switching element is closed, the laser fiber has already entered cw operation with an at least approximately constant output power P and, accordingly, the laser pulse used for the material processing, which is represented in the curve a, does not have an overshoot. The pulse duration T_{c} of the square-wave current pulse J represented in the curve b in this case is longer by the delay time T_{d}, in order to achieve a pulse duration Tₚ of the laser pulse desired or required for the processing operation.

The drive parameters of the fiber laser, illustrated in the application by way of example with the current pulse used for driving the diode laser, or the switching behavior of the optical switching element 16, depend in this case on the switch-on behavior of the fiber laser respectively being used, and need to be determined beforehand by measurement and stored in the control device 14 at least for each fiber laser type.

Such prior calibration or regular control measurement, and re-establishment of the drive parameters of the current source, or of the switching time of the optical switching element, can be obviated when, in the embodiment of the laser system according to FIG. 4, a measurement quantity correlated with the output power of the fiber laser is recorded. To this end, for example, a small part of the laser beam is extracted by reflection and the power of the extracted laser beam is recorded in a radiation detector 18. A measurement signal M generated by the radiation detector 18 is forwarded to the central control unit 14. A control signal S4 for controlling the optical switching element 16 is derived from the measurement signal M and the optical switching element 16 is closed when, for example, a decay of the power of the relaxation pulse to a predetermined value, for example to a percentage value relative to its maximum value, is established in the control unit 14. Particularly highly reproducible processing results can be achieved when the predetermined value is at least two times, preferably at least 1.5 times, in particular at least 1.1 times, the desired cw power, or when the reaching of a cw plateau is established.

Such a minimum delay time T_{d,min} preferred according to the invention is represented in the diagram of FIG. 3, in which the optical switching element 16 is already closed when the output power P of the relaxation pulse has decayed to about two times the cw power, which is about 200 W in the example represented, and in this example a value of about 400 W has been reached. This is because it has been found that, in practice, it can be sufficient for the initial overshoot, that is to say, in the event of early triggering (closure) of the switching element, with the output power P still present at the triggering time in the decaying edge because of a relaxation peak, not to exceed two times the cw output power P_{cw}.

The diagrams represented by way of example show square-wave laser pulses in which the output power is constant in cw operation. In principle, however, pulse shapes in which the output power in cw operation is not constant, but is for example modulated, are also possible.

In the exemplary embodiments represented, the optical switching element 16 is disposed outside the laser fiber 4. In principle, however, it is also possible to integrate the switching element 16 into the laser fiber 4.

1. A method for material processing using a pulsed laser beam generated by a fiber laser, the method comprising the following steps:
providing an optical switching element in a beam path of the laser beam; and
closing the optical switching element at the earliest when an output power of the laser beam falls below a predetermined value.

2. The method according to claim 1, which further comprises carrying out the step of closing the optical switching element at the earliest when the output power of the laser beam falls below two times a cw output power occurring within a pulse duration when cw operation is reached.

3. The method according to claim 2, wherein the output power of the laser beam when the optical switching element is closed exceeds the cw output power by at most 50%.

4. The method according to claim 2, wherein the output power of the laser beam when the optical switching element is closed exceeds the cw output power by at most 10%.

5. The method according to claim 1, which further comprises recording a measurement quantity correlated with the output power of the laser beam and using the measurement quantity to control the optical switching element.

6. A device for material processing, the device comprising:
a fiber laser having a laser fiber, said fiber laser configured to generate a pulsed laser beam along a beam path having an output power;
a diode laser configured to pump said laser fiber of said fiber laser;
a controllable current source configured to supply said diode laser with a current pulse;
an optical switching element disposed in said beam path of said laser beam; and
a control unit configured to close said optical switching element at the earliest when said output power of said laser beam falls below a predetermined value.

7. The device according to claim 6, which further comprises:
a radiation detector configured to measure and record a measurement quantity correlated with said output power of said laser beam;
said control unit configured to use said measurement quantity to control said optical switching element.

8. The device according to claim 6, wherein said optical switching element is integrated into said laser fiber.
